(19) United States
(12) Patent Application Publication
(10) Pub. No.: US 2012/0194881 A1
(43) Pub. Date: Aug. 2, 2012

(54) IMAGE SENSING APPARATUS

(75) Inventor: Yoshiyuki Okuda, Kai (JP)

(73) Assignee: PIONEER CORPORATION, Kawasaki-shi, Kanagawa (JP)

(21) Appl. No.: 13/391,208

(22) PCT Filed: Aug. 21, 2009
(86) PCT No.: PCT/JP2009/064639

§ 371 Date: Apr. 18, 2012

(51) Int. Cl. H04N 1/04

(52) U.S. Cl. 358/474

(57) ABSTRACT

The image sensing apparatus includes an intermediate electrode disposed between the electron emission source array and the photoelectric conversion film; an intermediate-electrode current detection portion for detecting an intermediate electrode current flowing in the intermediate electrode when an electron is emitted from the electron emission source array to the photoelectric conversion film; an intermediate current complete integrator for generating an integration signal by performing complete time integration of the intermediate electrode current; and an intermediate-electrode signal generating device for generating an intermediate electrode signal by sampling the integration signal for every pixel period that is a period for supplying electrons to each of the pixel regions.

### TECHNICAL FIELD

The present invention relates to an imaging image sensing apparatus comprising an image sensing element that includes an electron emission source array in which electron emission sources are arranged and a photoelectric conversion film, and a driving circuit for driving the image sensing element.

### BACKGROUND TECHNOLOGY

An image sensing apparatus is proposed wherein it is equipped with an electron emission source array in which electron emission sources are arranged in a matrix so as to draw out an electron by applying an electric field and with a photoelectric conversion film. For example, as an electron emission source (cold cathode electron source), a HEED (High-efficiency Electron Emission Device) is proposed (for example, Non-Patent Document 1).

The HEED is characterized in that it can be driven at a low voltage and the configuration thereof is simple, and application research of image sensing devices have been promoted. In addition, as a photoelectric conversion film, a HARP (High-gain Avalanche Rushing amorphous Photo conductor) photoelectric conversion film can be cited.

However, there was a problem in that when a high brightness image was entered, because there were too many hole electric charges accumulated in a pixel region of a photoelectric conversion film to read image information, a predetermined amount of emitted electrons was not sufficient to neutralize the accumulated holes, causing a detection signal to be saturated.

Moreover, there was a problem attributed to a defective pixel in a cold cathode array, for example, there was a pixel that could not detect (or reproduce) an image signal because an electron was not emitted (or amount of emitted electrons was almost zero), or there was a pixel in which signal saturation occurred even with a normal brightness because an amount of emitted electrons did not reach a criteria value, or the like.

Furthermore, the defective pixel described above becomes a black dot all the time and the black dot becomes an unpleasant noise in terms of image quality. Conventionally, in a processer to adjust a reproduced signal in a subsequent process, a so-called signal interpolation was performed wherein an average value was calculated from reproduced signals of pixels of right and left, or right, left, up, and down, or the like so as to replace with a signal of a black dot pixel. However, according to a conventional processing, a pixel to interpolate was specified from a reproduced image, which presented a problem in that it was difficult to determine whether a sensed image pixel was black or it was black due to a defect. Moreover, there was a problem in that a pixel that suddenly malfunctioned while being used was not corrected.

### PRIOR ART DOCUMENTS

### Non-Patent Document

Non-Patent Document 1: PIONEER R&D, Vol. 17, No. 2, 2007, pp. 61-69

### SUMMARY OF THE INVENTION

### Problem to be Solved by the Invention

The present invention was made in light of the above point, and a purpose thereof is to provide an image sensing apparatus for accurately detecting a non-electron-emission pixel (i.e., non-electron-emission source) of a cold cathode array or an insufficient electron emission pixel (low electron emission source) in which an amount of emitted electrons does not reach a criteria value, for example. Moreover, it is to provide an image sensing apparatus for accurately detecting a defective pixel such as a residual-electric-charge pixel or the like of a photoelectric conversion film. Furthermore, it is to provide a high image quality, high performance, and high-reliability image sensing apparatus that is capable of accurately performing electron emission control and imaging data interpolation processing, for example.

Moreover, it is to provide a high image quality, high performance, and highly reliable image sensing apparatus that is capable of performing at a high speed.

### Means for Solving the Problem

The image sensing apparatus of the present invention includes an electron emission source array in which a plurality of electron emission sources are arranged in a matrix; a photoelectric conversion film arranged opposing the electron emission source array; and a scanning driver that scans the electron emission source array and sequentially supplies electrons to a plurality of pixel regions in the photoelectric conversion film; wherein a photoelectric conversion film current flowing by combining an electron emitted from the electron emission source array with a hole generated in the photoelectric conversion film by light incidence thereon is obtained as output of an image signal; the apparatus includes an intermediate electrode disposed between the electron emission source array and the photoelectric conversion film; an intermediate-electrode current detection portion for detecting an intermediate electrode current flowing in the intermediate electrode when an electron is emitted from the electron emission source array to the photoelectric conversion film; an intermediate current complete integrator for generating an integration signal by performing complete time integration of the intermediate electrode current; and an intermediate-electrode signal generating device for generating an intermediate electrode signal by sampling the integration signal for every pixel period that is a period for supplying electrons to each of the pixel regions.

### BRIEF DESCRIPTION OF THE DRAWINGS

FIG. 1 A cross section schematic diagram illustrating the configuration of a HARP image sensing element with a HEED cold cathode.

FIG. 2 A block diagram illustrating the configuration of a HEED cold cathode array, a Y scanning driver and an X scanning driver to drive a HEED cold cathode array, and a controller to control an entirety of the apparatus.

FIG. 3 A diagram illustrating the configuration of an active drive type HEED cold cathode array, i.e., a cross section schematic diagram illustrating a pixel portion.

FIG. 4 A schematic diagram illustrating the configuration of an image sensing apparatus of the embodiment.

FIG. 5 A block diagram illustrating the configuration of a MESH signal processing portion.

FIG. 6 A diagram illustrating an example of a complete integral circuit.

FIG. 7 A schematic diagram illustrating an output signal waveform of each component of a MESH signal processing portion.

FIG. 8 A schematic diagram illustrating a MESH current waveform and a MESH current integration waveform that passes an LPF.

FIG. 9 A block diagram illustrating the configuration of a MESH signal processing portion of Embodiment 2.

FIG. 10 A schematic diagram illustrating an output signal waveform of each component of the MESH signal processing portion illustrated in FIG. 9.

FIG. 11 A block diagram illustrating the configuration of a HARP signal processing portion of Embodiment 3.

FIG. 12 A schematic diagram illustrating an output signal waveform of each component of the HARP signal processing portion illustrated in FIG. 11.

FIG. 13 A schematic diagram illustrating a HARP signal waveform and a MESH signal waveform, that is, a change in the current flowing in a HARP photoelectric conversion film and a change in the current flowing a mesh electrode.

FIG. 14 A flow chart illustrating the steps of an additional electron emission control operation executed by control of a controller.

FIG. 15 A schematic diagram illustrating an operation of dot sequential scanning of a pixel of a scanning line performed by a scanning drive in the X direction (horizontal direction), and an operation of additional electron emission at a scanning line Yj.

FIG. 16 A flow chart illustrating the steps of a data interpolation processing operation executed by control of a controller.

FIG. 17 A schematic diagram illustrating an operation of dot sequential scanning of a pixel of a scanning line performed by a scanning drive in the X direction (horizontal direction), and an integration reset operation at a horizontal scanning line Yk.

### BEST MODE CARRYING OUT THE INVENTION

Below, the embodiments of the present invention will be described by referencing the drawings. In the description of the drawings, portions substantively equal to or equivalent to are given the same referential numerals.

### Embodiment 1

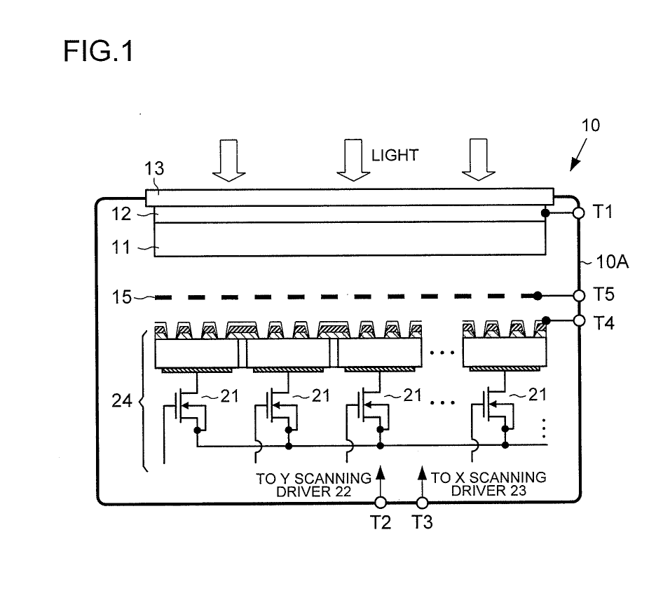

FIG. 1 is a cross section schematic diagram illustrating the configuration of a HARP image sensing element 10 with a HEED cold cathode. The HARP image sensing element 10 with a HEED cold cathode (hereafter, also referred to as a cold cathode image sensing element) is an image sensing element by combining a cold cathode array of an active drive type HEED (High-efficiency Electron Emission Device) and a HARP (High-gain Avalanche Rushing amorphous Photoconductor) photoelectric conversion film. More specifically, the cold cathode image sensing element 10 comprises a HARP photoelectric conversion film 11, a HEED cold cathode array chip 24, a mesh electrode (or intermediate electrode) 15 disposed between the HARP photoelectric conversion film 11 and the HEED cold cathode array 20. As described below, the HEED cold cathode array chip 24 is formed by integrating the cold cathode array of an active drive type HEED (hereafter, simply referred to as a HEED cold cathode array) 20, a Y scanning driver 22, and an X scanning driver 23 (not illustrated). In the description a photoelectric conversion film having a HARP structure is used as a photoelectric conversion film, and a cold cathode array having a HEED structure is used as a cold cathode array, however, these are merely an example, and a photoelectric conversion film and a cold cathode array having a different configuration, respectively, can be used.

As illustrated in the drawing, the HARP photoelectric conversion film 11 is formed on a light-transmissive conductive film 12 and the light-transmissive conductive film 12 is formed on a light-transmissive substrate 13. The HARP photoelectric conversion film 11 primarily consists of amorphous selenium (Se), however, other materials can be used such as a composite semiconductor or the like including silicon (Si), lead oxide (PbO), selenium cadmium (CdSe), gallium arsenide (GaAs), or the like, for example. The light-transmissive conductive film 12 may be formed of a tin oxide (Sn0₂) film, ITO (indium tin oxide) film, or the like. As described below, a predetermined positive voltage (hereafter, also referred to as a HARP potential or HARP voltage) is applied to the light-transmissive conductive film 12 via a connecting terminal (input/output terminal) T1 disposed in a glass housing 10A. The light-transmissive substrate 13 may be formed of a material to transmit a light having a wavelength of an image taken by the cold cathode image sensing element 10. For example, when an image is taken by a visible light, it is formed of a material to transmit the visible light such as a glass or the like, whereas when an image is taken by an ultraviolet light, it is formed of a material to transmit the ultraviolet light such as sapphire, quartz glass, or the like. Moreover, when an image is taken by an X ray, it may be formed of a material to transmit the X ray such as beryllium (Be), silicon (Si), boron nitride (BN), aluminum oxide (Al₂O₃), or the like, for example.

A mesh electrode 15 is disposed with a plurality of openings, formed of a known metal material, alloy, semiconductor material, or the like. A predetermined positive voltage (hereafter, also referred to as a mesh voltage or mesh potential) is applied to the mesh electrode 15 via a connecting terminal T5. The mesh electrode is an intermediate electrode disposed so as to accelerate an electron and recover extra electrons.

The HEED cold cathode array 20 will be described in detail later. A gate electrode of a MOS (Metal Oxide Semiconductor) transistor to drive the HEED is connected to the X scanning driver 23 (horizontal scanning circuit), and a source electrode (S) is connected to the Y scanning driver 22 (vertical scanning circuit) so as to perform dot sequential scanning. The Y scanning driver 22 and the X scanning driver 23 are constituted to be one chip integrally with the HEED cold cathode array 20 on the HEED cold cathode array chip 24, disposed in a glass housing 10A (not illustrated). A signal, voltage, or the like required to drive the HEED cold cathode array chip 24 is supplied via connecting terminals (input/output terminal) T2, T3, T4 disposed in the glass housing 10A.

All of these components are vacuum-encapsulated in the glass housing 10A that is sealed with a fritted glass or indium metal.

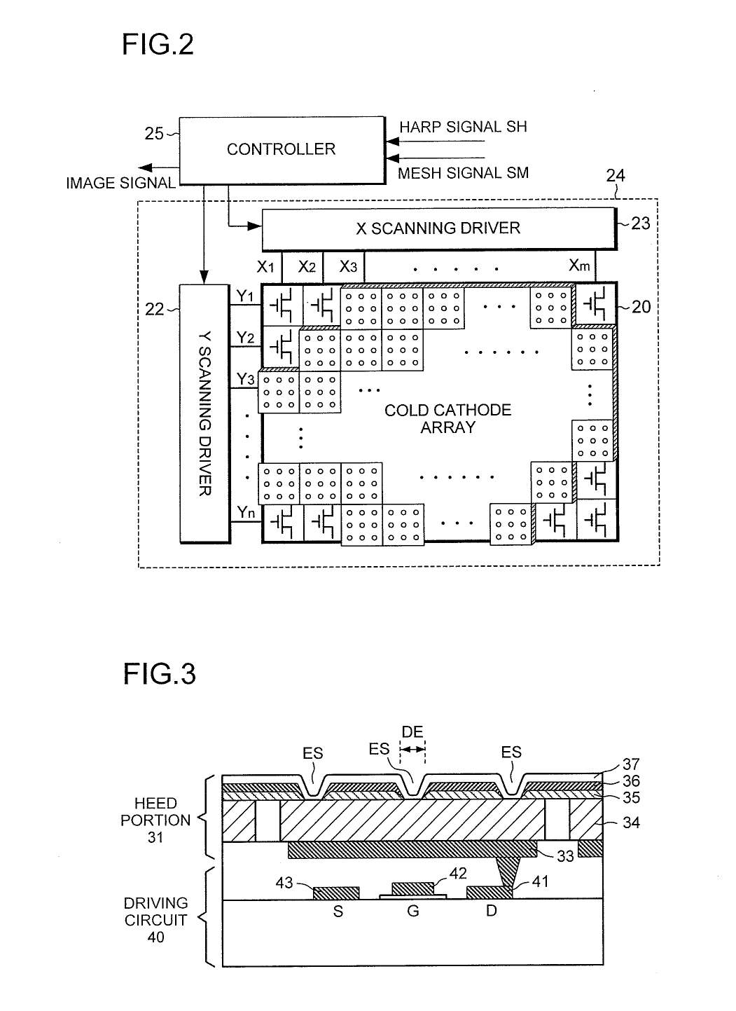

FIG. 2 is a block diagram illustrating the configuration of a HEED cold cathode array 20, a Y scanning driver 22 and an X scanning driver 23 to drive the HEED cold cathode array 20, and a controller 25 to control an entirety of the apparatus. The Y scanning driver 22 and the X scanning driver 23 are constituted to be one chip as the HEED cold cathode array chip 24. The controller 25 and other circuits to be described below may be disposed on the chip.

As schematically illustrated in FIG. 2, the HEED cold cathode array 20 is constituted to be an integrated active drive type field emitter array (FEA) on a driving circuit LSI formed on an Si wafer with the HEED cold cathode array as a direct stacked layer so that it can correspond to high-speed drive (for example, drive pulse width of one pixel is several dozen ns) of an image sensing operation to perform the dot sequential scanning. The HEED cold cathode array 20 consists of a plurality of pixels in matrix arrays of “n” rows and “m” columns (number of pixels is n×m) connected to scanning drive lines (hereafter, simply referred to as scanning lines) of “n” lines and “m” lines in the Y direction (vertical direction) and X direction (horizontal direction) respectively. For example, it is constituted to be a cold cathode array of a high-definition HEED of 640×480 pixels (VGA standard).

The Y scanning driver 22 and the X scanning driver 23 perform the dot sequential scanning and drive the pixels based on a control signal such as a vertical synchronous signal (V-Sync), a horizontal synchronous signal (H-Sync), a clock signal (CLK), or the like from the controller 25. In other words, the scanning lines (Yj, j=1, 2, . . . n) are sequentially scanned in the Y direction, wherein when one scanning line (Yk) is selected, scanning lines (Xi, i=1, 2, . . . m) are sequentially scanned in the X direction so as to select and drive each pixel on the scanning line (Yk), thereby performing the dot sequential scanning.

FIG. 3 is a diagram illustrating the configuration of a cold cathode array of an active drive type HEED, or a local cross section schematic diagram illustrating an enlarged pixel portion. In the HEED cold cathode array 20, a driving circuit 40 consisting of a MOS transistor array, and a Y scanning driver 22 and an X scanning driver 23 for drive controlling the driving circuit 40 are formed, and then a HEED portion 31 is formed on the driving circuit 40.

As illustrated in FIG. 3, the HEED portion 31 is a MIS (Metal Insulator Semiconductor) type cold cathode electron emission source having a stacked structure of a lower electrode 33, a silicon (Si) layer 34, a silicon oxide (SiOx) layer 35, an upper electrode 36 consisting of tungsten (W), for example, and a carbon (C) layer 37. The upper electrode 36 of the HEED cold cathode array 20 is common to all pixels, and the lower electrode 33 and the Si layer 34 are divided so as to electrically separate pixels.

The lower electrode 33 of the HEED portion 31 is connected to a drain electrode D of a MOS transistor of the driving circuit 40 via a via hole. Moreover, as described above, the gate electrode G and source electrode S of the MOS transistor are connected to the X scanning driver 23 and Y scanning driver 22. Switching of a pixel to emit an electron is performed by controlling a drain potential of the MOS transistor, i.e., a potential of the lower electrode 33 of each pixel of the HEED portion 31.

Moreover, the number of pixels of the HEED cold cathode array 20 is 640×480 pixels (VGA), for example, and the size of one pixel is 20×20 μm². An emission site ES that is an opening for emitting an electron is disposed on the surface of a pixel. For example, 3×3 pieces of emission sites ES having a diameter DE (φ: 1 μm) of approximately 1 μm are formed in an area of one pixel of 8×8 μm². From one emission site ES, for example, an electron flow of several microampere (μA) is emitted (or emission current density is approximately 4 A/cm²). The values used in the embodiment are mere examples, which can be accordingly changed for applications depending on a device using an image sensing element, and a resolution, sensitivity, or the like of the image sensing element.

### [Configuration and Operation of the Image Sensing Apparatus]

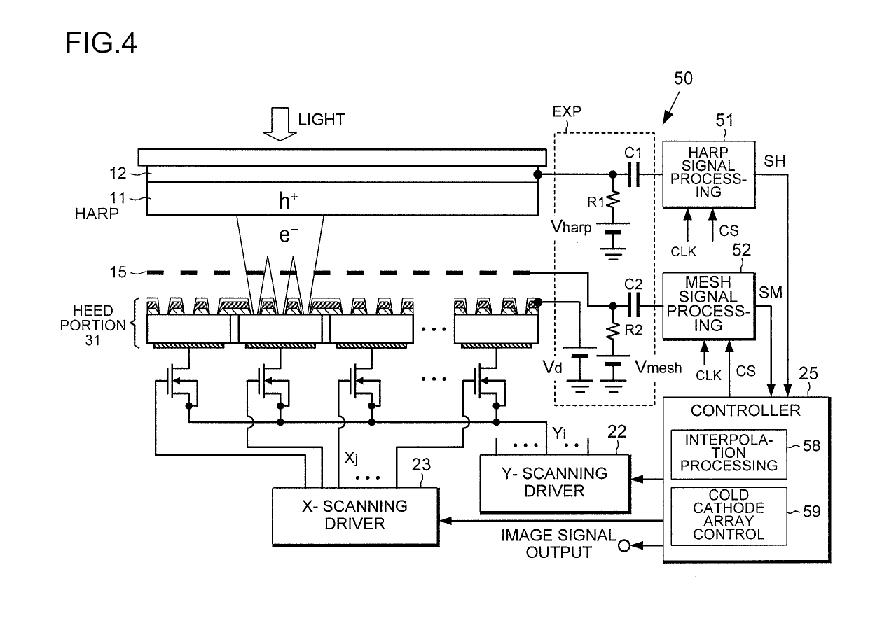

FIG. 4 is a schematic diagram illustrating the configuration of an image sensing apparatus 50 of the present embodiment. The image sensing apparatus 50 is provided with a HARP signal processing portion 51 that is a photoelectric conversion signal processing portion and a mesh electrode signal processing portion (hereafter, referred to as a MESH signal processing portion) 52. A HARP signal SH and a mesh electrode signal SM detected by the HARP signal processing portion 51 and the MESH signal processing portion 52 are supplied to the controller 25.

Moreover, as illustrated in FIG. 4, the light-transmissive conductive film 12 is connected to an external power source circuit EXP so as to apply a predetermined positive voltage (HARP voltage) Vharp to the HARP photoelectric conversion film 11 and is connected to the HARP signal processing portion 51 via a capacitor C1. Moreover, a predetermined positive voltage (mesh voltage or MESH voltage) Vmesh is applied to the mesh electrode 15 which is connected to the MESH signal processing portion 52 via a capacitor C2. According to the configuration, a predetermined positive voltage (HEED drive voltage) Vd is applied to an upper electrode 36 of the HEED portion 31. To exemplify these voltage values, Vharp=1.5 kV, Vmesh=470 V, Vd=23 V, however, they are not limited to these values.

The operation of the image sensing apparatus 50 will be described below. When an external light is entered the HARP photoelectric conversion film 11 via the light-transmissive conductive film 12, a pair of electron and hole are formed in the conversion film in the vicinity of the light-transmissive conductive film 12 according to an amount of incident light. The hole is accelerated by a high electric field applied to the HARP photoelectric conversion film 11 via the light-transmissive conductive film 12, sequentially colliding with an atom comprising the HARP photoelectric conversion film 11, thereby producing electron-hole pairs. As described above, the holes undergoing an avalanche multiplication are accumulated in the side opposing to the HEED cold cathode array 20 of the HARP photoelectric conversion film 11 (opposite side of the light-transmissive conductive film 12), thereby forming a hole pattern corresponding to an image of the incident light. A current generated by combination of the hole pattern and electrons emitted from the HEED cold cathode array 20 is outputted as a HARP current according to the image of incident light.

Each component of the image sensing apparatus 50 including the Y scanning driver 22, the X scanning driver 23, the image signal detection portion 51, and the controller 25 (synchronously) operates based on a clock signal (CLK), thereby performing various operation such as detection of each signal, driving of the driver, processing of signals, or the like described herein.

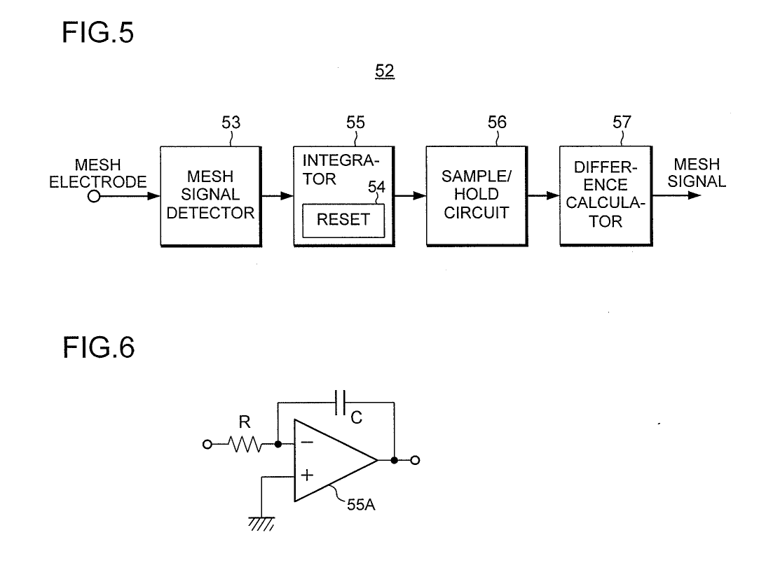

FIG. 5 is a block diagram illustrating the configuration of the MESH signal processing portion. The MESH signal processing portion 52 includes a MESH signal detector 53, an integrator 55, a sample hold circuit 56, and a difference calculator 57. As described above, each of these components of the MESH signal processing portion 52 operates based on a control signal CS and clock signal (CLK) from the controller 25.

Herein, the integrator 55 is a complete integrator performing true integral operation. FIG. 6 illustrates one example of the complete integral circuit. As illustrated in FIG. 6, the complete integral circuit can be realized as an active circuit comprising an operational amplifier 55A, resistance (R), and capacitor (C).

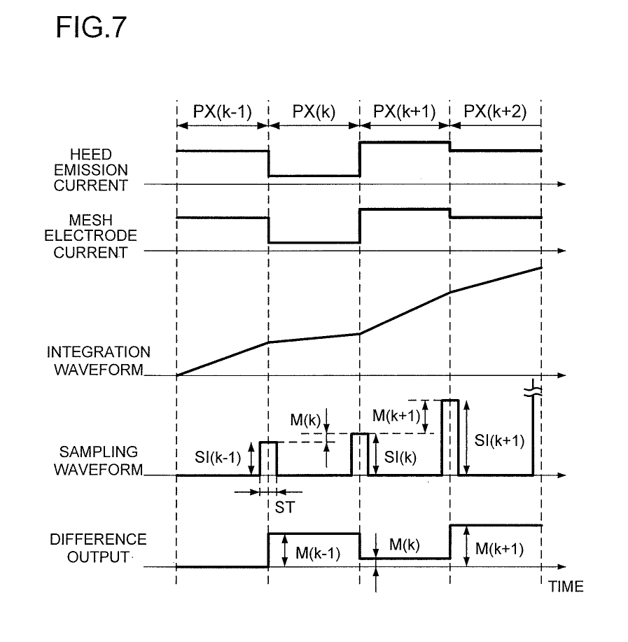

FIG. 7 schematically illustrates an output signal waveform of each component of the MESH signal processing portion 52. In order to simplify the description and facilitate understanding, sequential four pixels PX(k−1) to PX(k+2) are illustrated. The periods of the pixels (referred to as a pixel period) will be described by referring them as pixel periods PX(k−1), PX(k), PX(k+1), and PX(k+2). In an image sensing apparatus of 640×480 pixels (VGA standard), generally the length of the pixel period is approximately dozens of nanoseconds, for example, 80 ns.

The MESH signal processing portion 52 is connected to the capacitor C2 provided with the mesh electrode 15, and performs processing of a mesh electrode signal for each pixel based on the clock signal (CLK) so as to generate a mesh signal (MESH signal: SM).

FIG. 7 schematically illustrates a case in which of the pixels PX(k−1) to PX(k+2) of the HEED cold cathode array 20, the amount of emitted electrons (emission current) from the element corresponding to the pixel PX(k) does not reach a criteria value. As illustrated in FIG. 7, a mesh electrode current (or intermediate electrode current) flows according to the amount of emitted electrons from each pixel of the HEED cold cathode array 20. The integrator 55 performs time integration (i.e., time complete integral) of a mesh current (hereafter, referred to as a MESH current) for every pixel period. The sample/hold circuit 56 samples an integration waveform of the MESH current for a predetermined sampling period ST at an end portion of each pixel period so as to hold a sampling value. The difference calculator 57 subtracts an integration value of a preceding pixel period from an integration value of a current pixel period (integration period) so as to output a difference. Specifically, the difference calculator 57 subtracts an integration value (SI(j−1)) of a pixel period PX(j−1) from an integration value (SI(j)) of a pixel period PX(j), sequentially outputting a difference thereof M(j) (j=1, 2, . . . ) so as to generate a MESH signal SM. FIG. 7 illustrates sequential output of M(k−1), M(k), M(k+1). The integrator 55 is provided with a reset circuit 54 (FIG. 5), wherein the integrator 55 is constituted to continue the integration of the MESH current for a predetermined period, and to be reset after an elapse of the predetermined period (predetermined number of pixel periods).

As described above, the pixel PX(k) is an insufficient electron emission pixel in which the amount of emitted electrons thereof does not reach the criteria value of electrons, however, according to the present embodiment, it is possible to accurately detect an insufficient electron emission pixel, PX(k), in the MESH signal SM. In other words, this is because the MESH signal value M(k) of the pixel PX(k) can obtain a true integration value for the pixel period PX(k).

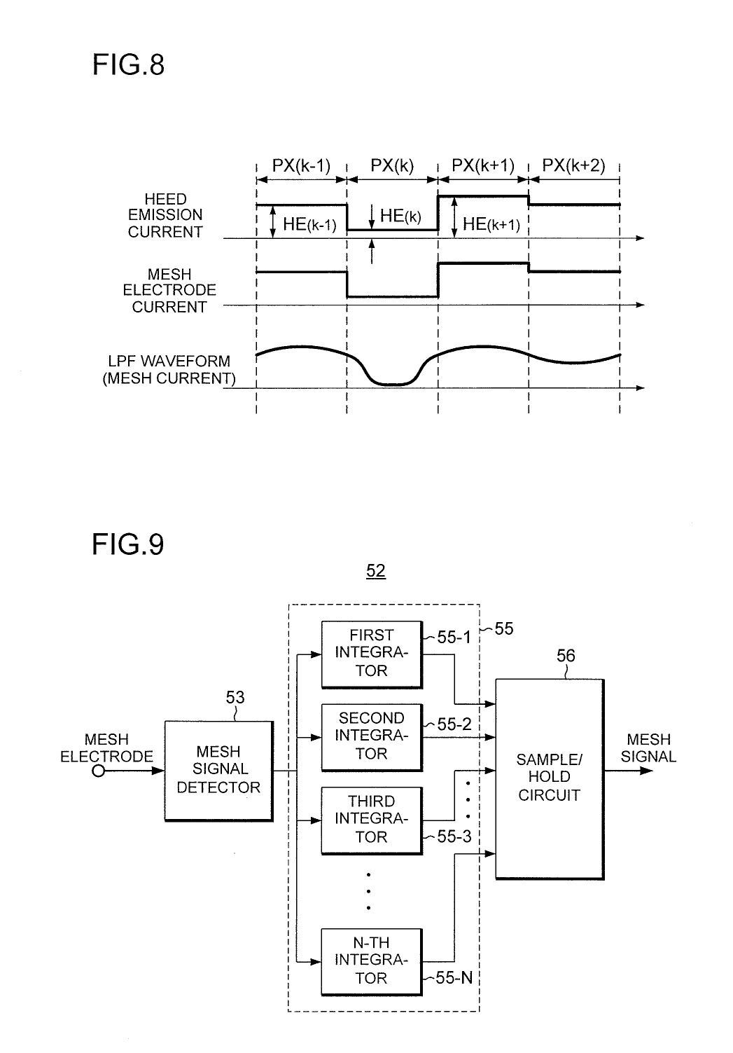

In other words, when a method in which a electrode signal component was extracted by passing through an incomplete integrator such as a conventional LPF (low pass filter) or the like was applied to detecting a MESH signal, it was difficult to accurately detect a non-electron-emission pixel (non-electron-emission source) or insufficient electron emission pixel (low electron emission source) in which the amount of emitted electrons does not reach the criteria value. For example, as the incomplete integrator, a passive circuit comprising passive elements such a resistance (R), capacitor (C) or inductor (L), or the like can be cited. FIG. 8 illustrates an integration waveform of a MESH current by means of the LPF (incomplete integrator) as a comparative example of the present embodiment. As illustrated in FIG. 8, when there is a variation in the amount of emitted electrons of each electron emission element, the MESH current of an insufficient electron emission pixel or non-electron-emission pixel (PX(k)) is significantly different from a MESH current of an adjacent normal pixel, hence the integration waveform is anomalously modulated after it passes the incomplete integrator (LPF). In other words, unlike the MESH current that is uniform, a frequency component is produced by the anomalous modulation of a bandwidth of the LPF. Therefore, when there is a variation in the amount of emitted electrons of an electron emission element, it appears in a MESH signal as a noise, causing a ratio of a signal and noise (S/N) to decrease, thereby decreasing the detection accuracy of the electron emission pixel. Furthermore, there has been an increasing demand for higher definition of an image sensing apparatus, and when a high-speed operation described above is required, the problem arises more prominently.

According to the present invention, the complete integrator 55 is used to process a mesh electrode signal of each pixel so as to generate a MESH signal, hence it is possible to accurately detect an electron emission source which does not emit electrons or an electron emission source in which an amount of emitted electrons does not reach a criteria value. Moreover, it is possible to determine if it is a non-electron-emission pixel (non-electron-emission pixel) or a pixel in which the amount of emitted electrons does not reach the criteria value (insufficient electron emission pixel). Furthermore, it is possible to precisely detect the amount of emitted electrons of a pixel in which the amount of emitted electrons exceeds the criteria value (electron emission source) as well as that of a pixel in which it does not reach the criteria value.

### Embodiment 2

FIG. 9 is a block diagram illustrating the configuration of the MESH signal processing portion that is Embodiment 2 of the present invention. The MESH signal processing portion 52 comprises a MESH signal detector 53, a first integrator, a second integrator, . . . N-th integrator 55-1, 55-2, . . . 55-N, and a sample/hold circuit 56. In the above-mentioned Embodiment 1, a case in which one complete integrator is provided was described, however, in the present embodiment, N(N is an integer equal to or greater than 2) pieces of complete integrators are provided. The first integrator, second integrator to N-th integrator 55-1, 55-2, . . . 55-N are collectively called the integrator 55. As described above, each of these components of the image signal detection portion 51 operates based on the control of the controller 25 and clock signal (CLK).

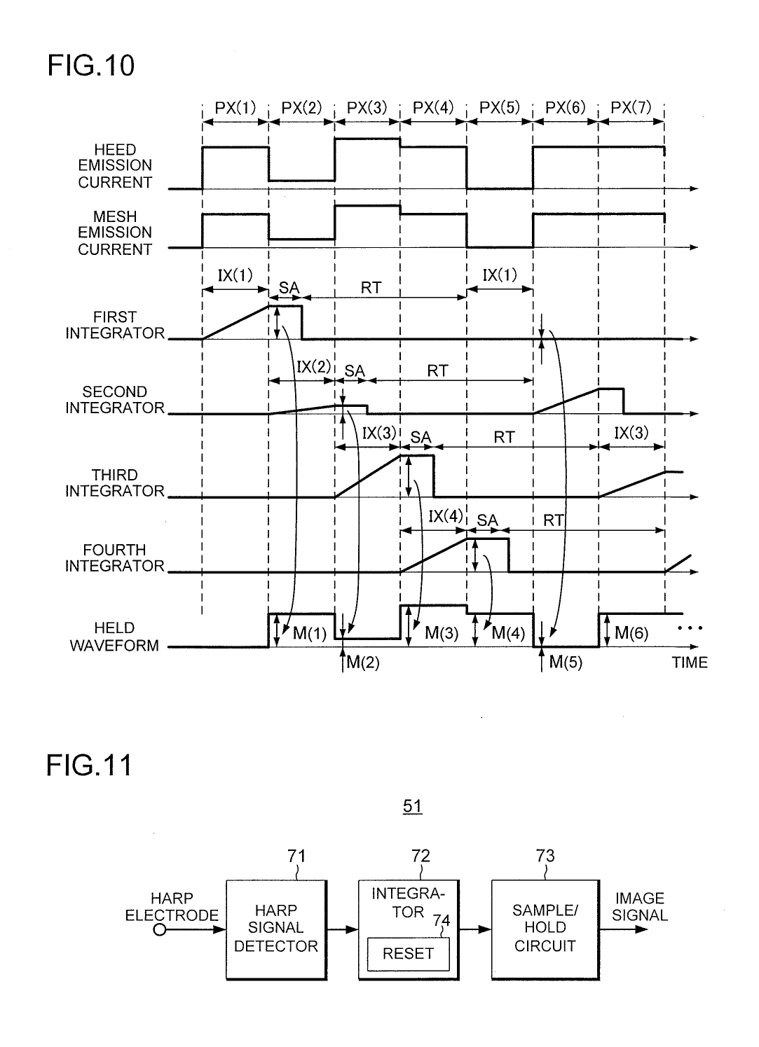

FIG. 10 is a schematic diagram illustrating output signal waveforms of the respective components of the MESH signal processing portion 52. In order to facilitate understanding and simplify the description, the drawing illustrates the image signal detection portion 51 comprising four integrators (N=4), i.e., the first to fourth integrators 55-1 to 55-4, and first to seventh pixel PX(j) (j=1-7).

The first to fourth integrators 55-1 to 55-4 respectively integrate the MESH current for each of the pixel periods PX(4k−3), PX(4k−2), PX(4k−1), . . . PX(4k) (k is a natural number). To be more specific, the first integrator 55-1 integrates the MESH current for the pixel period PX(1), PX(5), PX(9) . . . . First, an integration waveform (first integration waveform) of the pixel period PX(1) is obtained by the first integrator 55-1. The sample/hold circuit 56 samples the integration waveform of the MESH current for the pixel period PX(2) following the pixel period PX(1) (sampling period SA) so as to hold the integration value (M(1)) sampled. After sampling is finished, the integration value of the subsequent pixel period is reset (reset time RT).

The reset operation of the integrator is performed by the control of the controller 25 that functions as resetting means. The resetting means resets the first integrator 55-1 such that the integration operation starts from the starting time of the pixel period PX(5) that is the next pixel period executing the integration of the first integrator 55-1.

The second integrator 55-2 integrates the MESH current for the pixel period PX(2). The sample/hold circuit 56 samples the integration waveform of the MESH current for the pixel period PX(3) following the pixel period PX(2) so as to hold the sampling value (M(2)). The reset operation of the second integrator 55-2 (integration waveform) by the resetting means is similar to that of the above-mentioned first integrator 55-1 so as to reset the second integrator 55-2 such that the integration operation of the second integrator 55-2 starts from the starting time of the pixel period PX(6) that is the next pixel period performing the integration of the second integrator 55-2.

Similarly, the MESH current is integrated for the pixel period PX(3), PX(4) by the third integrator 55-3 and fourth integrator 55-4, respectively. Then the third and fourth integration waveforms are sampled for the subsequent pixel periods PX(4) and PX(5) in the sample/hold circuit 56 so as to obtain sampling values M(3) and M(4). The integration and sampling hold operations are repeated, wherein a signal consisting of sampling value M(1), M(2), M(3), M(4) . . . is outputted from the sample/hold circuit 56 as a MESH signal SM (FIG. 10).

FIG. 10 schematically illustrates a case in which the amount of emitted electrons (i.e., emission current) from an element corresponding to the pixel PX(2) does not reach the criteria value. In other words, through the complete integration, the insufficient electron emission pixel PX(2) (integration value M(2)) can be accurately detected. Moreover, the first integrator 55-1 integrates the MESH current for the pixel period PX(5), and through the complete integration, it is possible to accurately detect that the pixel PX(5) is a non-electron-emission pixel (non-electron-emission source) (integration value M(5)).

Therefore, according to this configuration, wherein each of the two or more integrators sequentially integrates for the corresponding pixel period, each of the pixel periods can be made shorter than that of the above-described embodiment. Moreover, by increasing the number of the integrators, the pixel period can be made much shorter. Since the MESH signal is generated by the complete integrator 55, even when the pixel period is shortened, it is possible to precisely detect a pixel which does not emit an electron (i.e., non-electron-emission pixel) or a pixel in which the amount of emitted electrons does not reach the criteria value (i.e., insufficient electron emission pixel). As described above, according to the present embodiment, it is possible to provide a higher-definition image sensing apparatus than Embodiment 1.

### Embodiment 3

FIG. 11 is a block diagram illustrating the configuration of the HARP signal processing portion 51 that is Embodiment 3 of the present invention. The HARP signal processing portion 51 comprises a HARP signal detector 71, a complete integrator 72, and a sample/hold circuit 73. As described above, these components of the HARP signal processing portion 51 operate based on a control signal CS from the controller 25 and a clock signal (CLK).

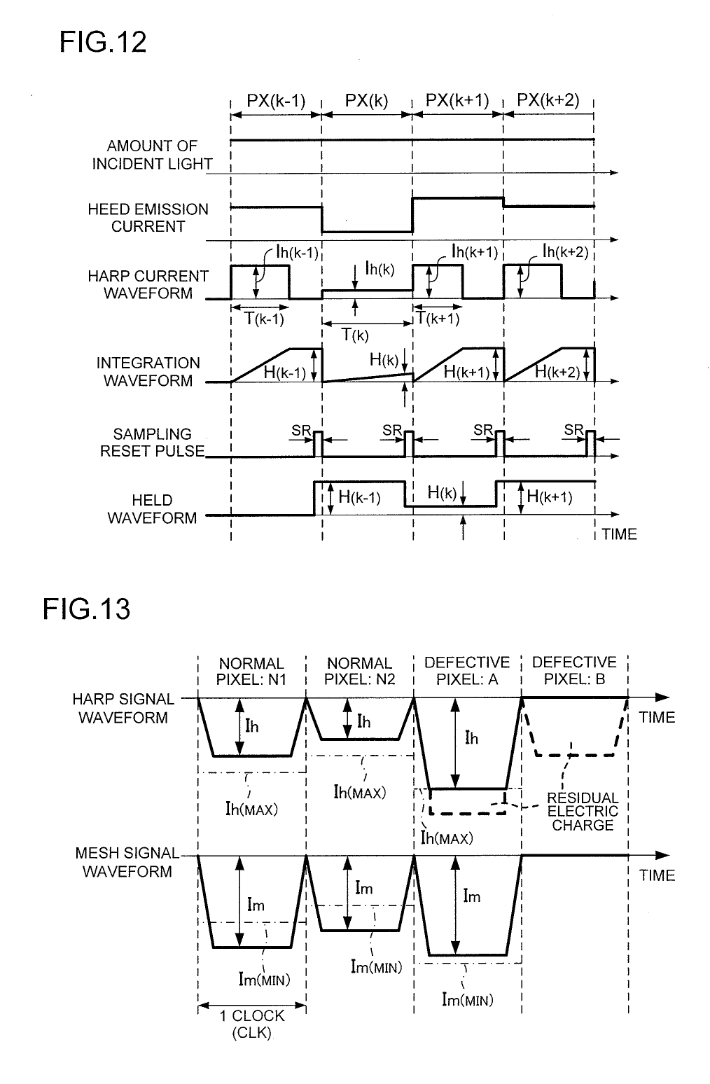

FIG. 12 is a schematic diagram illustrating output signal waveforms of the respective components of the HARP signal processing portion 51. In order to simplify the description and facilitate understanding, sequential four pixels PX(k−1) to PX(k+2) are illustrated. The HARP signal processing portion 51 is connected to the capacitor C1 connected to the light-transmissive conductive film 12, and performs processing of a HARP electrode signal for each pixel based on the clock signal (CLK) so as to generate a HARP signal (image signal) SH.

FIG. 12 illustrates a case in which the amounts of incident light in regions (pixel regions) corresponding to the pixels PX(k−1) to PX(k+2) of the HARP photoelectric conversion film 11 are equal.

The integrator 72 is provided with a reset circuit 74 similarly to that of Embodiment 1. The integrator 72 resets the integration value when each pixel period is finished and performs a complete integration of a HARP current for each of the pixel periods PX(k−1) to PX(k+2). As illustrated in FIG. 12, the integration waveform of the HARP current becomes a fixed value after a period from the start of each pixel period until a neutralized current stops flowing (duration of the neutralized current). In other words, after a period in which neutralization of holes accumulated in each pixel region is completed, it becomes a constant integration value H(j) corresponding to the amount of incident light in each pixel region. More specifically, an integration value H(j) (j=1, 2, . . . , k, . . . ) represents the brightness of each pixel (hereafter H(j) is also referred to as a pixel value). Then the integrator 72 resets the integration value when each pixel period is finished.

Even if the amount of incident light in each pixel region of the HARP photoelectric conversion film 11 is equal to each other, the duration T(j) (hereafter, referred to as a HARP current period) of the HARP current (neutralized current) is different when the amount of emitted electrons from the electron emission source (pixel) of the HEED cold cathode array 20 corresponding to the pixel region is different. For example, the amount of emitted electrons of the pixel PX(k−1) of the HEED cold cathode array 20 is smaller than the amount of emitted electrons of the pixel PX(k+1), the durations of the HARP current (neutralized current) for the pixels are different, i.e., T(k−1)<T(k+1). Moreover, when the amount of emitted electrons of the pixel (PX(k)) does not reach the criteria value, neutralization is not completed within the pixel period. As described above, even if the HARP current waveforms have different pulse widths, it is possible to precisely detect a HARP current value (pixel value) by the complete integration.

The sample/hold circuit 73 samples an integration waveform of the HARP current for a predetermined sampling reset period SR at an end portion of each pixel period, and holds the sampling value, and thereafter resets the integrator 72 for the sampling reset period SR. Then the sample/hold circuit 73 outputs the hold value as a HARP signal (image signal) SH. Therefore, the HARP signal processing portion 51 is capable of generating an accurate image signal corresponding to the amount of incident light in each pixel region of the HARP photoelectric conversion film 11.

[Control and Interpolation Processing of the Cold Cathode Array]

The controller 25 is provided with an interpolation processing portion 58 and a cold cathode array control portion 59 (FIG. 4). The controller 25 performs cold cathode array control and signal interpolation processing based on the HARP signal SH and the MESH signal SM detected by the HARP signal processing portion 51 and the MESH signal processing portion 52. Each component of the image sensing apparatus 50 including the Y scanning driver 22, the X scanning driver 23, the HARP signal processing portion 51, the MESH signal processing portion 52, and the controller 25 operates based on a control signal CS from the controller 25 and a clock signal (CLK) (synchronously), thereby performing various operations such as detection of various signals, driving of the driver, processing signals, or the like, described here.

The controller 25 determines a pixel region in which holes remaining (hereafter, referred to as a residual-electric-charge pixel) of the HARP photoelectric conversion film 11 based on the HARP signal SH and the MESH signal SM from the HARP signal processing portion 51 and the MESH signal processing portion 52, and also determines a pixel of the HEED cold cathode array 20 that does not emit an electron or in which the amount of emitted electrons does not reach the criteria value (ε) (hereafter, referred to as a non-electron-emission pixel).

FIG. 13 is a schematic diagram illustrating a HARP signal waveform and a MESH signal waveform, i.e., a change in the currents in the HARP photoelectric conversion film 11 and the mesh electrode 15. Herein, the currents (absolute values) of the HARP photoelectric conversion film 11 and the mesh electrode 15 will be referred to as a HARP current Ih and a MESH current Im in the description respectively. There are various methods for detecting and determining a defective pixel such as the residual-electric-charge pixel or non-electron-emission pixel described above, however, the following method is preferred.

The HARP current Ih varies depending on the amount of incident light (brightness) of each pixel, and the MESH current Im also varies depending on the amount of emitted electrons of each pixel of the HEED cold cathode array 20. Moreover, the HARP current Ih and the MESH current Im vary depending on an electron transmission ratio (k) of the mesh electrode 15. Herein the electron transmission ratio (k) is a value defining the transmission ratio of the electrons of the mesh electrode, and as an opening area ratio of the mesh, a known value which is constant in the plane is used. Alternately, instead of the known value, it is acceptable to obtain an opening ratio distribution for each area by an experiment or the like so as to use this as the electron transmission ratio. Herein, with regard to a residual-electric-charge pixel, the following relationship is established: Ih=Ih(MAX) or Im=Im(MIN). However, in reality, it is difficult to detect a state only to satisfy these relationship equations in terms of a problem such as a noise or the like. Therefore, in reality it is preferred to set an appropriate determining range (range exceeding a threshold value such as Ih(th) obtained by multiplying Ih(MAX) by a predetermined coefficient, Im(th) obtained by multiplying Im(MIN) by a predetermined coefficient, or the like) represented in the following equations. Therefore, it is preferred to determine a residual-electric-charge pixel and non-electron-emission pixel by defining a criteria value Ih(th) and Im(th) based on the following equations.

Ih+Im=Ie (1)

Ie×k=Ih(MAX), Ie×(1−k)=Im(MIN) (2)

0.9×Ih(MAX)=Ih(th), 1.1×Im(MIN)=Im(th) (3)

The determining criteria expression is as follows.

Ih>Ih(th) or Im<Im(th) (4)

Ie<ε (5)

In the present embodiment, the lower limit value of a current amount that can be read out is defined to be ε.

For example, it is possible to determine that a residual-electric-charge pixel (hereafter, collectively referred to as defective pixel type A or pixel A) is a pixel to satisfy the above criteria equation (4). Moreover, it is possible to determine that a non-electron-emission pixel in which the amount of emitted electrons does not reach the criteria value (ε) (hereafter, collectively referred to as defective pixel type B or pixel B) is a pixel to satisfy the above criteria equation (5). In this case, it also satisfies the criteria expression (4) simultaneously. The coefficient of the equation (3) is not limited to 0.9 or 1.1. Moreover, the above determining criteria expression may include a normal pixel, wherein a balance is considered between removal of a noise effect and stability of the circuit.

It is preferred that the processing to detect whether or not there is a residual-electric-charge pixel and/or non-electron-emission pixel to perform compensation is performed for each frame from a viewpoint of improving the image quality, however, the processing is not limited to this. For example, the processing can be performed, for example, for a plurality of frames collectively depending on a circuit size or processing capability.

Since each pixel is subjected to detection, it is possible to perform a compensation operation for a horizontal blanking period immediately after the detection. Moreover, it is also possible to perform a compensation operation for a plurality of horizontal blanking periods after the detection so as to produce more effect of removing a residual-electric-charge.

The determining method will be specifically described by referencing FIG. 13. In the drawing, a normal pixel (N1) indicates that the amount (or brightness) of incident light is large to generate a large electric charge. In this case, Ie (=Ih+Im) is relatively large. In other words, it is possible to determine that this is a normal pixel since the amount of emitted electrons is sufficient although the criteria value Im (th) is large, and there is no residual-electric-charge generated since Ih is equal to or smaller than Ih(th) (Ih≦Ih(th)).

A normal pixel (N2) indicates a case in which it generates smaller electric charges than a pixel (N1) and the amount of emitted electrons is smaller. In this case, Ie (=Ih+Im) is smaller than that of the pixel (N1). Specifically, since Im is equal to or greater than the Im(th) (Im≧Im(th)) while the criteria value Im(th) is small, the amount of emitted electrons is sufficient. In addition, although the criteria value Ih(th) is smaller than that of the pixel (N1), Ih is equal to or smaller than Ih(th) (Ih≦Ih(th)), thus there is no residual electric charge generated, hence it can be determined that this is a normal pixel.

A defective pixel A indicates a case in which the amount of incident light (brightness) is large, the amount of emitted electrons is large but insufficient, and there is a residual electric charge generated (Ih>Ih(th) and Im<Im(th)). A defective pixel B indicates a case in which the electron emission is small (Ie<ε) and a generated electric charge is produced as a residual electric charge. In these cases, they can be determined as defective pixels.

A method for detecting and determining of a non-electron-emission pixel and/or residual-electric-charge pixel is not limited to the methods described above. For example, a current value Ie (=Ih+Im) can be calculated so as to determine whether or not the current value exceeds a predetermined criteria value, thereby determining if there is a residual electric charge or not, or the pixel is a non-electron-emission pixel or not.

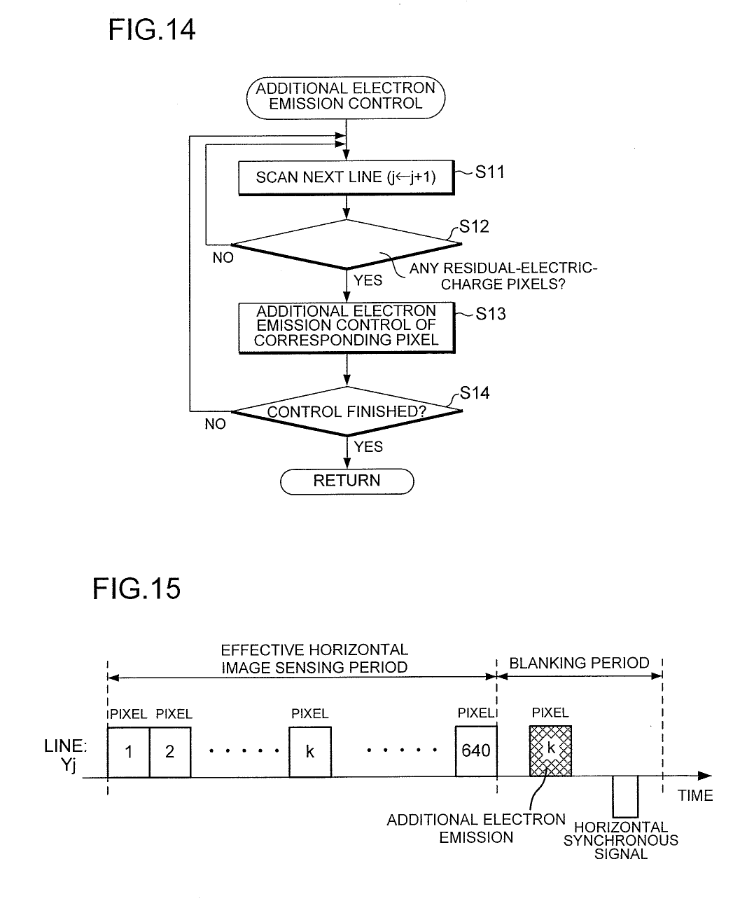

FIG. 14 is a flow chart illustrating the step of an additional electron emission control operation performed by control of the controller 25. FIG. 15 is a schematic diagram illustrating an operation of dot sequential scanning a pixel (1 to m, m=640) of a scanning line Yj by scanning drive in the X direction (horizontal direction) on the scanning line Yj, and an operation of additional electron emission.

First, in the dot sequential scanning (Step S11) of the scanning line Yj (j=1 at the start of an image frame), the controller 25 determines whether or not each of pixel 1 to pixel 640 in the horizontal direction is a residual-electric-charge pixel for an effective horizontal image period (Step S12), and when it is determined that it is the residual-electric-charge pixel, the position thereof (address, i.e., the row and column) is memorized. At Step S12, when it is determined that there is not a residual-electric-charge pixel on the scanning line, the process moves to Step S11 to repeat the above step for the next scanning line.

When it is determined that there is a residual-electric-charge pixel on the scanning line, the controller 25 controls the cold cathode array control portion 59 so as to emit additional electrons of the pixel of the HEED cold cathode array 20 corresponding to the determined pixel in the image blanking period after the scanning line (Yj) is scanned (Step S13). For example, when it is determined that the k-th pixel of the scanning line is the residual-electric-charge pixel, additional electron emission of the k-th pixel of the scanning line (Yj) of the HEED cold cathode array 20 is performed emitted in the blanking period.

The additional electron emission of the residual-electric-charge pixel has been described. However, it is possible to perform additional electron emission of a pixel in the vicinity of the residual-electric-charge pixel, for example, a pixel that is adjacent to the residual-electric-charge pixel in the horizontal or vertical direction.

Next, it is determined whether or not the additional electron emission control is finished (Step S14). When the additional electron emission control will be continued, the process moves to Step S11 so as to repeat the determination step of the residual-electric-charge pixel and the additional electron emission control similarly to the above step for the next scanning line Yj (j=j+1). At Step S14 when it is determined that the additional electron emission control is finished, this routine is finished.

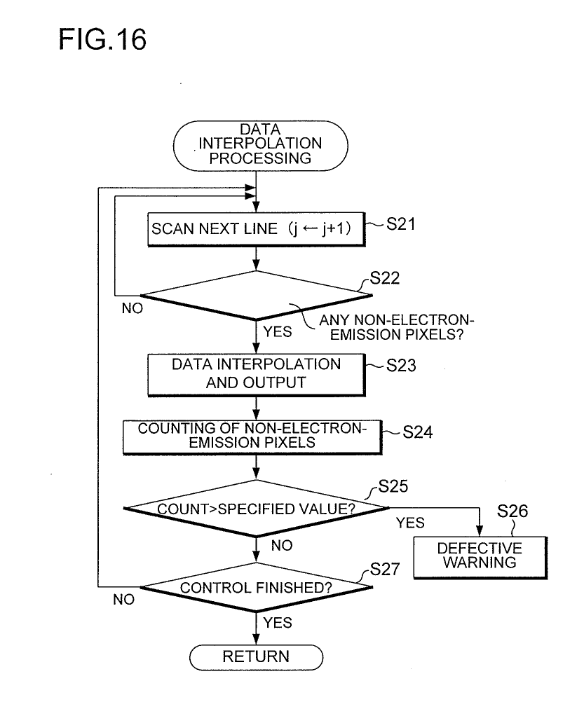

FIG. 16 is a flow chart illustrating the steps of the data interpolation processing operation performed under control of the controller 25. First, the scanning line Yj (j=1 at the start of an image frame) is subjected to the dot sequential scanning (Step S21). The controller 25 determines whether or not each of pixel 1 to pixel 640 in the horizontal direction is a non-electron-emission pixel. When it is determined that it is a non-electron-emission pixel, the position thereof (i.e., address) is memorized (Step S22).

When a non-electron-emission pixel is detected, the controller 25 controls the signal interpolation processing portion 58 so as to perform a signal interpolation processing. The signal interpolation processing portion 58 uses brightness (amount of light) data of the pixel adjacent to the non-electron-emission pixel in the horizontal and/or vertical direction so as to perform the interpolation processing of the brightness data of the non-electron-emission pixel(s). The controller 25 is provided with a memory (not illustrated) to memorize sensed image data. Then, the controller 25 outputs the data interpolated by the signal interpolation processing portion 58 as an image data signal (or image signal) (Step S23).

Furthermore, the controller 25 counts the number of non-electron-emission pixels (or defective pixels) (Step S24) so as to determine if the count value exceeds the specified value or not (Step S25). When the count value exceeds the specified value, the defect is notified by displaying a defect warning on the display or the like (Step S26).

At Step S25, when it is determined that the count value does not exceed the specified value, it is determined if the interpolation processing control is finished or not (Step S27). When the interpolation processing control is continued, the process moves to Step S21 to repeat the above-mentioned step for the next scanning line. When it is determined that the interpolation processing control is finished, this routine is finished.

Each step of the additional electron emission control and data interpolation processing control has been described. However, needless to say, these controls can be combined for application.

According to the present embodiment, the complete integrator 55 is used to process a mesh electrode signal for each pixel so as to generate a MESH signal, hence it is possible to accurately detect an electron emission source which does not emit an electron or an electron emission source in which the amount of emitted electrons does not reach the criteria value. Furthermore, since it is possible to accurately detect and determine an electron emission pixel which does not emit an electron (non-electron-emission source) or an insufficient electron emission pixel in which the amount of emitted electrons does not reach the criteria value (low electron emission source), it is possible to precisely detect and determine a residual-electric-charge pixel based on the result of the detection and the determination method such as the above-mentioned equations (1) to (5). Moreover, it is possible that only a pixel in which the amount of electron emission does not reach the specified value and which need additional electron emission is subjected to additional electron emission so that effects can be obtained such as improving the life of a cold cathode, suppressing an extra electron, or the like. Therefore, it is possible to provide a high image quality, high performance, and high-reliability image sensing apparatus that is capable of accurately performing electron emission control and image data interpolation processing or the like.

### Embodiment 4

In the description of the above Embodiment 1, the integrator 55 is constituted such that it continues to integrate the MESH current for the predetermined period, and an integration signal (integration value) is subjected to the reset operation for each of the predetermined periods (predetermined number of pixel periods) when the last pixel period is finished.

However, it is possible to constitute it such that the reset operation is performed for every predetermined period. For example, the integrator 55 can continue integrating the MESH current throughout the scanning period of a horizontal scanning line Yk (k-th scanning line) as the predetermined period, thereby performing the reset operation for each scanning of the horizontal scanning line. Below, the reset operation of each scanning of the horizontal scanning line will be described as an example.

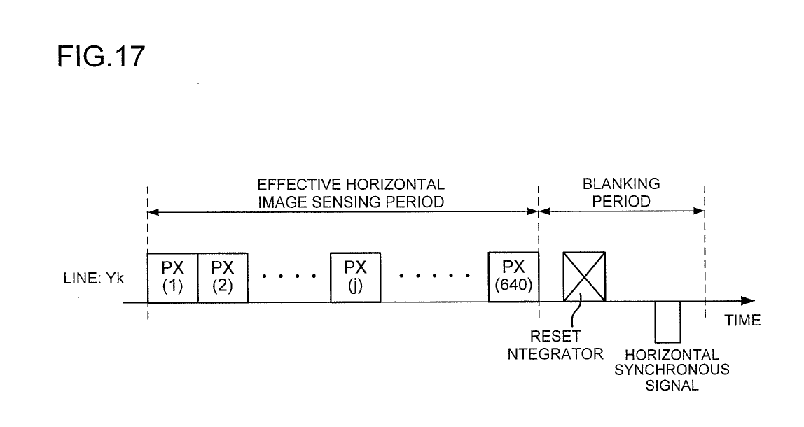

FIG. 17 is a schematic diagram illustrating an operation of the dot sequential scanning for a pixel PX(j) (j=1 to m, m=640) of the scanning line by scanning drive in the X direction (horizontal direction) for the horizontal scanning line Yk (k=1 to n) and an integration reset operation. More specifically, the integrator 55 continues to integrate throughout one effective horizontal scanning period, and performs the reset operation of the integrator 55 for the image blanking period after scanning the scanning line (Yk). As described above, the integrator 55 repeats the integration operation from the first scanning line Y1 to the n-th scanning line Yn and the reset operation of the integrator 55 under the control of the controller 25.

The sample/hold circuit 56 samples an integration waveform of the MESH current in a predetermined sampling period ST at an end portion of each pixel period so as to hold the sampling value. Then the sample/hold circuit 56 supplies a sampling value of each pixel period PX(j) (j=1 to m) to the difference calculator 57.

As described above, the difference calculator 57 subtracts an integration value of a preceding pixel PX(j−1) from an integration value of a current pixel PX(j), to sequentially output a difference thereof M(j) (j=1, 2, . . . ) so as to generate a MESH signal SM.

According to the present embodiment, the reset operation of the integrator 55 is performed in the blanking period after the effective horizontal scanning period that is a period other than the pixel periods. The reset operation of the integrator 55 may take approximately several nanoseconds to 10-20 nanoseconds for drawing out an electric charge of the integrator 55, for example. According to the present embodiment, the reset operation is performed within the blanking period without setting a reset period for each pixel period.

Even when the integrator 55 is constituted to continue integrating the MESH current throughout a predetermined number of pixel periods so as to perform the reset operation for every predetermined number of pixel periods, the difference calculator 57 can be configured such that it calculates a difference in the MESH current between a preceding pixel and a current pixel.

As described above, according to the present embodiment, it is not necessary to set a reset period in each pixel period, hence it is possible to set the pixel period short and to provide an image sensing apparatus having a capability of high-speed operation.

As described above in detail, the complete integrator is used to process a mesh electrode signal for each pixel so as to generate a MESH signal, hence it is possible to provide an image sensing apparatus that is capable of accurately detecting and determining a non-electron-emission pixel (non-electron-emission source) which does not emit an electron or an insufficient electron emission pixel (low electron emission source) in which the amount of emitted electrons does not reach the criteria value. Moreover, it is possible to precisely detect the amount of emitted electrons of a pixel, particularly the amount of emitted electrons of an insufficient electron emission pixel. Furthermore, it is possible to more precisely detect and determine the residual-electric-charge pixel based on the detection and determination result of the electron emission source. Therefore, it is possible to provide a high image quality, high performance, and high-reliability image sensing apparatus that is capable of accurately performing the electron emission control and imaging data interpolation processing or the like.

The above embodiments can be suitably combined for application. Moreover, according to the above embodiment, a case in which a HEED cold cathode array was used as a cold cathode array and a HARP photoelectric conversion film was used as a photoelectric conversion film was used to describe as an example, however, it can be applied to an image sensing apparatus using various cold cathode arrays, electron supplying sources, and photoelectric conversion films. The materials, values, or the like used in the above embodiment are merely an example.

### EXPLANATION OF THE REFERENCE NUMERALS

10 . . . HARP IMAGE SENSING ELEMENT WITH A HEED COLD CATHODE
11 . . . PHOTOELECTRIC CONVERSION FILM
15 . . . MESH ELECTRODE
20 . . . HEED COLD CATHODE ARRAY
25 . . . CONTROLLER
51 . . . HARP SIGNAL PROCESSING PORTION
52 . . . MESH SIGNAL PROCESSING PORTION
54, 74 . . . RESET CIRCUIT
55, 72 . . . INTEGRATOR

1. An image sensing apparatus comprising: an electron emission source array in which a plurality of electron emission sources are arranged in a matrix; a photoelectric conversion film arranged opposing said electron emission source array; and a scanning driver that scans said electron emission source array and sequentially supplies electrons to a plurality of pixel regions in said photoelectric conversion film; wherein a photoelectric conversion film current flowing by combining an electron emitted from said electron emission source array with a hole generated in said photoelectric conversion film by light incidence thereon is obtained as output of an image signal; the apparatus comprising:
an intermediate electrode disposed between said electron emission source array and said photoelectric conversion film;
an intermediate-electrode current detection portion for detecting an intermediate electrode current flowing in said intermediate electrode when an electron is emitted from said electron emission source array to said photoelectric conversion film;
an intermediate current complete integrator for generating an integration signal by performing complete time integration of said intermediate electrode current; and
an intermediate-electrode signal generating device for generating an intermediate electrode signal by sampling said integration signal for every pixel period that is a period for supplying electrons to each of said pixel regions.

2. The image sensing apparatus according to claim 1, comprising reset means for resetting said integration signal for every horizontal scanning period of said electron emission source array.

3. The image sensing apparatus according to claim 2, wherein said resetting means resets said integration signal within a blanking period of scanning of said electron emission source array.

4. The image sensing apparatus according to claim 2, comprising a difference calculator for calculating a difference in a sampling value of said integration signal for every said pixel period.

5. The image sensing apparatus according to claim 1, wherein said intermediate current complete integrator comprises a plurality of complete integrators for sequentially performing complete time integration of said intermediate electrode current for every said pixel period.

6. The image sensing apparatus according to claim 1, comprising:
a photoelectric-conversion-current complete integrator for generating an integration signal by performing complete time integration of said photoelectric conversion film current; and
a photoelectric-conversion-current signal generating device for generating an image signal by sampling said integration signal for every pixel period to supply an electron to each of said pixel regions.
